(19) United States
(12) Patent Application Publication
(10) Pub. No.: US 2003/0041385 A1
(43) Pub. Date: Mar. 6, 2003

(54) Humphreys fire-rescue tool

(76) Inventor: John Echols Humphreys, Autryville, NC (US)

Correspondence Address: JOHN E. HUMPHREYS, 4119 MINNIE-HALL RD, AUTRYVILLE, NC, 28318, US

(21) Appl. No.: 09/943,309

(22) Filed: Aug. 31, 2001

(51) Int. Cl. B25D 1/04

(52) U.S. Cl. 7/145

(57) ABSTRACT

The HUMPHREYS FIRE-RESCUE TOOL is a multi-purpose, adjustable length combination tool which provides the fire-rescue worker the ability to perform a wide variety of tasks. The tool may be separated into two tools by removing the pry bar from the handle of the maul. This permits the user to drive the pry bar with the hammer into the material to be pried. The hammer can then be replaced on the pry bar to increase leverage for prying. This tool will supplement and often eliminate the need to carry bulky tools such as the axe, hammer, pry tools, short pike pole, gas wrench, chisel, and Glass Master. The firefighter can carry this 6.5-pound tool on his belt by means of an integral belt clip. This leaves both hands free to perform other tasks such as pulling a hoseline, yet the tool is available when it is needed. No other fire tool is as versatile or convenient to use.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### BACKGROUND OF THE INVENTION

The HUMPHREYS FIRE-RESCUE TOOL is a hand tool for use by fire-fighters and rescue personnel engaged in structural fire fighting and emergency rescue operations. Fire-fighters do not have a convenient, easy-to-carry, multi-purpose tool for forcing doors, cutting internal walls, cutting car windshields, and other tasks required on an emergency scene. Currently, these tasks require the use of several tools including the axe, sledgehammer, Halligan tool, plaster hook, Glass Master, and others. These tools are still important but the fire-fighter cannot carry them while he is dragging a hoseline or performing other tasks. A small multi-purpose tool that can be carried on the belt is required.

### BRIEF SUMMARY OF THE INVENTION

The HUMPHREYS FIRE-RESCUE TOOL is a small, lightweight, multi-purpose combination tool that can be used for a wide variety of tasks on the fireground or accident scene. The tool has a belt hook to facilitate easy carrying while the user's hands are busy with other tasks. The tool has an adjustable shaft to increase the users reach. The pry bar may be removed from the hammer shaft so that the user can drive it with the hammer then replace the hammer shaft on the pry bar for increased leverage. This tool can be effectively used for: forcing doors and windows, cutting and pulling sheetrock to expose hidden fire, cutting an automobile windshield to access accident victims, prying battery cables off of the battery to reduce the threat of fire or airbag activation, turning off residential gas supply, chopping through walls to create an emergency egress. Fire-fighters routinely perform these tasks with several different bulky tools. This single tool will accomplish all of these tasks and the tool is hanging on the user's belt, where it is needed, rather than in a compartment on the firetruck.

### BRIEF DESCRIPTION OF THE SEVERAL VIEWS OF THE DRAWING

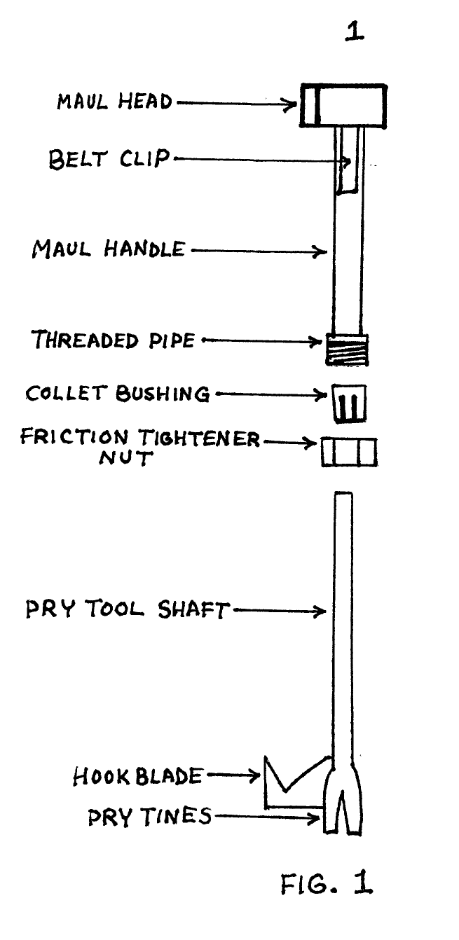

1. FIG. 1 EXPLODED VIEW-SIDE

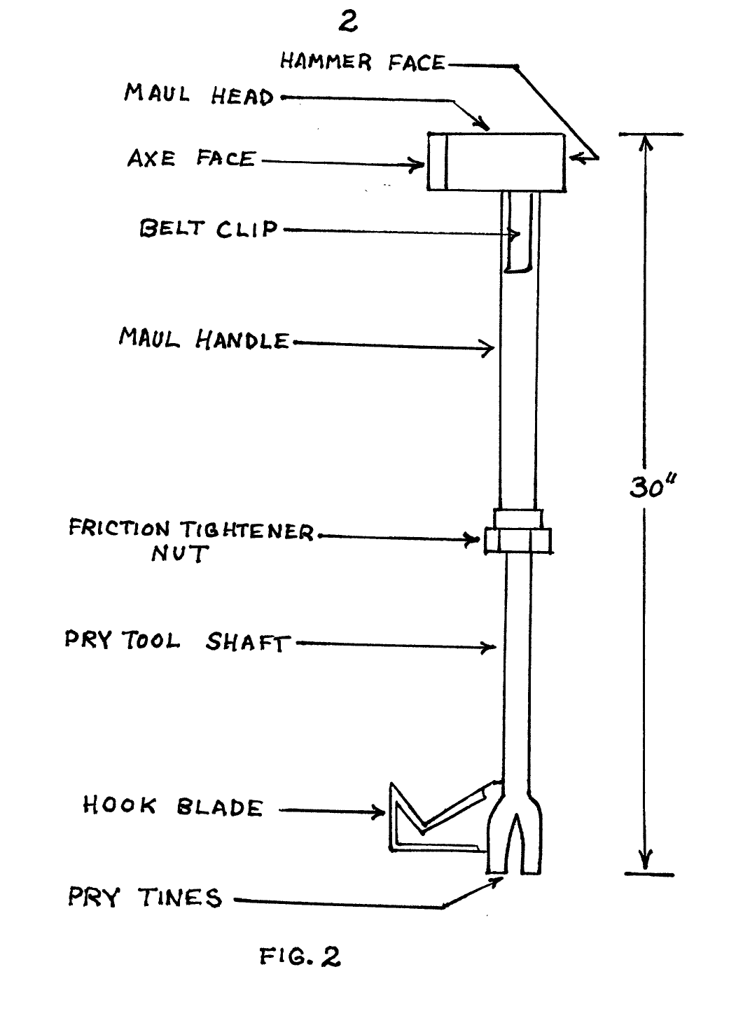

2. FIG. 2 TOOL EXTENDED-SIDE

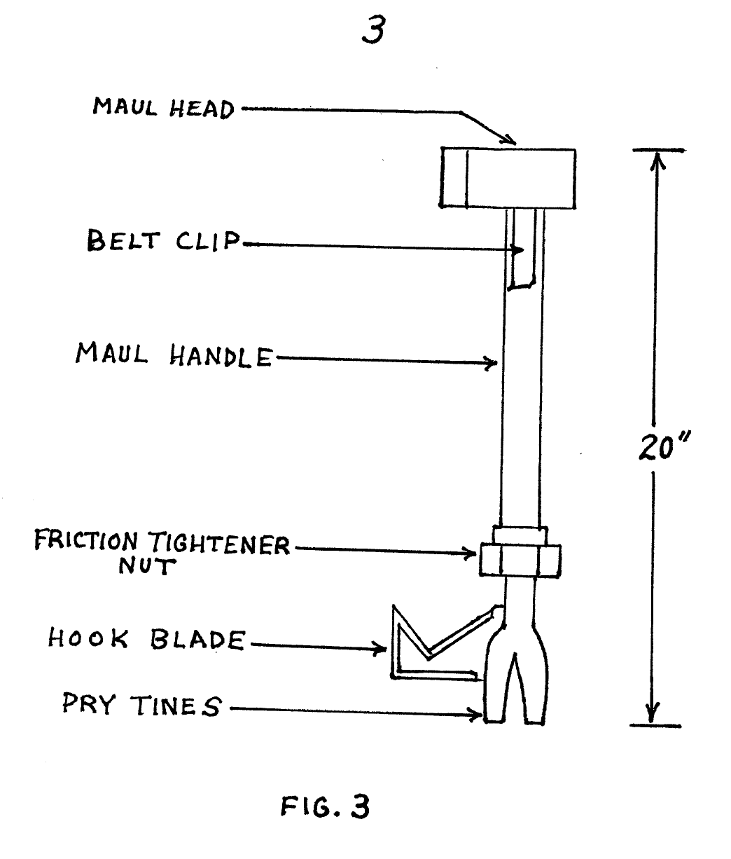

3. FIG. 3 TOOL COLLAPSED-SIDE

### DETAILED DESCRIPTION OF THE INVENTION

The HUMPHREYS FIRE-RESCUE TOOL consists of two pieces. The first is a 4-pound maul hammer, blunt on one side with a splitting edge on the other. This is arc welded to a mild steel tube 12-inches long, with a ⅞-inch inside diameter, ¼-inch thickness. This serves as a handle for the tool. On the end of the tube opposite the maul, is arc welded a 1¼-inch threaded pipe and a split collet friction tightener with an inside diameter of ¾-inch. The friction tightener has a rough knurled nut threaded with 1½-inch NC pipe thread. The second piece of the tool is hardened steel shaft, 14-inches long with a ¾-inch diameter. On the end of the shaft are two wedge shaped, hardened steel tines which are each ½-inch wide and separated by a ¾-inch gap which narrows to 0 inch at 3-inches of length. The sides of the gap are ground to a sharp edge with a 30-degree edge. The tines are sharp on the end, and are wedge shaped from the tip 3-inches long at a 35-degree angle. A hook-blade is welded to the side of the tines and shaft 1½ inches from the ends of the tines. The hook-blade is 4-inches long from the shaft with a 3-inch hook pointed opposite of the ends of the tines. The hook is straight cut at 30-degrees for 2-inches then 60-degrees for 3½-inches to the shaft. The top, front, and inside edges of the hook are ground sharp at a 45-degree angle edge. The hook is cut from mild steel plate ¼-inch thick. On the side of the maul handle immediately below the maul head is welded a belt clip. The clip is formed from mild steel strap 1-inch by ⅛-inch. The clip is 3-inches long. The tool handle is painted black and the maul head, tines, and hook blade are painted red.

1. What I claim as my invention is a multi-purpose fire and rescue tool with an adjustable length from 20 inches to 30 inches that serves as a plaster hook for tearing open walls to find and extinguish hidden fire.

2. What I claim as my invention is a fire tool which can be separated into two tools, a hammer and a pry bar. The hammer is used to drive the pry bar in between the surfaces to be separated, then can be replaced upon the pry bar as a longer handle to increase leverage for prying.

3. What I claim as my invention is a lightweight, multi-purpose fire and rescue tool that can be easily carried on the belt by means of a belt clip. This tool serves as an axe, hammer, pry bar, and hook blade.
